(19) United States
(12) Patent Application Publication
(10) Pub. No.: US 2012/0261146 A1
(43) Pub. Date: Oct. 18, 2012

(54) LIFT ASSIST WHEEL ASSEMBLY

(76) Inventor: FRIEDRICH GEORG BOLTEN, Kununarra (AU)

(21) Appl. No.: 13/448,942

(22) Filed: Apr. 17, 2012

(30) Foreign Application Priority Data
Apr. 17, 2011 (AU) 2011901428

(51) Int. Cl. A01B 69/00

(52) U.S. Cl. 172/1; 172/280

(57) ABSTRACT

A wheel attachment assembly (10) mountable to an agricultural implement (22) that is drawn by a vehicle having front steering wheels and, the assembly including: at least one ground engaging wheel (14, 14′); a lift actuator (34, 34″) for lifting the implement with respect to the wheel a mounting arrangement for mounting the assembly to the rear of the implement; and a steering mechanism (60) for steering the wheel, wherein the steering mechanism is controllable such that the at least one wheel is steered in cooperation with the vehicle front wheels when the vehicle is turning.

The present invention relates to a wheel attachment assembly suitable for providing guidance to a tractor drawn agricultural implement. In particular, the present invention relates to a wheel attachment assembly having both a lift assist capability and guidance for a tractor drawn implement.

### BACKGROUND OF THE INVENTION

Modern agricultures is often conducted on a large scale in which large agricultural machinery is used. Implements for carrying out an agricultural task such as preparing soil, planting, tending to or harvesting crops are pulled behind a tractor. Towed implements are connected to a tractor through a draw bar and as they carry their own weight, have their own running gear. They must have also have a means for controlling the working height of ground engaging tools and a means for lifting the tools clear of the ground for turns and transport.

A disadvantage of a towed implement is that it is only drawn from a single point and is able to swing towards the point of least resistance when towed. Thus, the tracking of the implement can respond to undulations in the terrain. Reversing is also extremely difficult.

Towed implements generally have additional steering or guidance devices. A simple guidance device has guide wheels or discs that ride along farrows and assist in keeping the implement on track. More sophisticated arrangements provide steering wheels on the implement or a steering mechanism to control the pivoting of the hitch. These arrangements typically use GPS guidance of the position of the implement and are computer controlled.

An alternative to towed implements is to connect them using a three point hitch mounted on the tractor. The lower two hitch arms carry at least some of the weight of the implement and the upper arm is a stabilizing arm. The hitch can also raise and lift the implement and control the working depth of the ground engaging tools (draft). The hitch also transfers the weight of the implement to the rear tractor wheels which increases traction. This arrangement offers significant advantages over towed implements including that they do not require their own running gear nor height control. This allows the implements to be less complex and lighter.

Two point hitches are also known. These are similar to a three point hitch in that they have two lifting bars but do not have the top stabilizer bar. Three point hitches are preferred over two point hitches and are considered the industry standard.

The present invention will be described with particular reference to a two or three point hitch mounted implement. However, it will be appreciated that the assembly of the present invention may also be used with a towed implement having a drawbar and no limitation is intended thereby.

In large scale crop operations optimization of productivity and efficiency is essential for profit realization. This can be done in a variety of ways. First, it is desirable to be able to work a large area of land with as few passes of the tractor and implement as possible. To this end, implements having a wide working width that can plough, till, plant, feed, weed or harvest have been adopted. Wider equipment means a greater area can be worked in a single day and planting and harvesting can be conducted in a smaller time window.

A compromise with increasing size is an increase in weight. This is a particular problem with tractors that use a two or three point hitch to carry the weight of the implement. For example, when an implement is lifted for turning or transport, the full weight of the implement is transferred to the rear wheels of the tractor. This can cause the tractor to become overloaded, increase tractor tyre wear and can create instability with associated safety issues.

It is also desirable to carry heavier loads of fertilizer, seeds, herbicides to reduce down time in refilling. Other applications that require moving bulk material include potato planting, cane planting and the like. Excess weight can damage soil and machinery.

In order to address the problem of lifting and carrying heavy implements with a two or three point linkage, it is known to provide auxiliary wheels that attach to the implement. These wheels are known in the art as lift assist wheels. Lift assist wheels are typically offset swivel castor wheels that are mounted to an implement. The castor wheels simply align with the direction of travel of the implement. If the implement drifts off course, the lift assist wheels will simply follow. The lift assist wheels have a hydraulic ram that applies an expanding force between the wheel and the implement thereby applying a lifting force to the rear of the implement to assist the tractor in lifting the implement through the three point hitch. When raised, the lift assist wheels can share some of the weight of the implement during transport and turning.

Broad acre farming refers to cropping a large area, for which such large agricultural machinery is used. In broad acre farming the working width of an implement is spread across the full width such that the soil is worked uniformly across the width. It will be appreciated that at least some tillage, planting and the like will be conducted on areas compacted by the tractor wheels. Further for working of a planted field some crop will be damaged by the tractor wheels.

In row cropping, seeds are planted in regularly spaced rows. Row cropping has a number of advantages over broad acre farming including allowing rows of crops to be planted tightly side to side, improved weed control and irrigation. Further, the ability to tightly control seed, fertilizer and selective herbicide to the rows and non-selective herbicide to the inter rows is also important in optimizing efficiency and productivity. Implements for row cropping are highly specialized so as accurately work the row width or interrow width as required.

In both broad acre or field and row cropping the tractor turns at the end of a pass to begin a return pass along the field. The area at the end of the pass is generally free of crop and is known as the headland or end row area.

A reduction in headland area translates directly into an increase in crop area. An increase of a meter or so at each end of a field over a large number of hectares can considerably increase productivity. Further, headland turns are considered to be the most time consuming part of working a field. The tractor speed must be reduced as the tractor reaches the end of the pass, the implement must be raised and the tractor turned with precision so that it travels along the correct position or row in the return pass. Turning accuracy is extremely important so as not to provide an excess gap between passes or to overrun passes. Both situations lead to a decrease in productivity. The ability to carry out a tight and accurate headland turn is highly desirable in both broad acre and row crop farming.

The minimum headland width only provides enough space for a tractor to make a U turn if the tractor can begin the turn at the end of the row. However, when the tractor is in this position, the implement has not reached the end of the row and is still working the soil or crop. Beginning the turn when the implement is still on the crop such that the implement does not finish in a true straight line can be tolerated in broad acre cropping. However, it cannot be tolerated with row cropping in which strict adhesion to straight rows is required.

One solution is to increase headland width such that the tractor can begin its turn when the implement has reached the end of the row. However, this requires an increase in headland width which decreases productivity. Thus, farmers have adopted a procedure in which the tractor stops after the implement has reached the end of the row, the implement is raised and the tractor is reversed until the rear wheels of the tractor meet the end of the row. The tractor and raised implement can then make the U turn in the headland.

Reversing at the end of passes is also required for irrigated row cropping where it is necessary to avoid an irrigation channel at the end of the row. Further, undulating ground is created by crop rows and irrigation channels between crop rows and this undulation needs to be traversed.

Conventional caster lift assist wheels can freely rotate in any direction and when an implement to which they are mounted changes to a reverse direction they rotate 180° about the swivel joint. This swivelling can damage crop rows together with making it difficult, if not impossible, to reverse in a strict straight line necessary required for row crop headland turns as described above. Further, this rotation can apply torque and stress on the joint, which can be greater than it is designed for. As a result a rotatable shaft of the joint can bend, and the tines of the fork that connect with the wheel to the shaft can also be broken.

It is therefore an object of the present invention to provide an alternative wheel attachment assembly for a drawn agricultural implement.

### BRIEF SUMMARY OF THE INVENTION

According to a first broad form of the invention, there is provided a wheel attachment assembly mountable to an agricultural implement that is drawn by a vehicle having front steering wheels, the assembly including:

at least one ground engaging wheel;

a mounting arrangement for mounting the assembly to the rear of the implement; and

a steering mechanism for steering the wheel, wherein the steering mechanism is controllable such that the wheel is steered in cooperation with the vehicle front wheels when the vehicle is turning.

The term “agricultural implement” refers to any agricultural machine capable of being drawn behind a vehicle such as a tractor to perform an agricultural operation such as preparation and maintenance of soil, seed planting, fertilizer application, weed control, harvesting and the like.

The term “vehicle” includes any vehicle capable of drawing any agricultural implement. A particularly suitable vehicle is as a tractor with a two or three point hitch.

The term “drawn” refers to an implement that is carried or towed by means of a draw bar or hitch. Preferably the implement is carried by a two or three point hitch in which the vehicle bears at last part of the weight of the implement. A suitable example is a three point hitch or linkage.

The term “wheel” includes any generally circular guidance device and can include a disc or coulter. Preferably, the guidance device is a pneumatic tyre wheel.

The assembly includes a mounting arrangement for mounting the assembly to the rear of the implement. Any suitable method of mounting the assembly to the implement may be used.

The steering mechanism is controllable to cooperate with the steering of the vehicle front wheels. Suitably the control is by computer.

Suitably, the steering mechanism is controlled so as to cooperate to turn the wheel(s) of the assembly in the opposite direction to that of the vehicle front wheels. This reduces the turning radius. The steering angle of the wheel(s) may be the same or different to that of the vehicle steering wheels. The relative steering ratio between the front vehicle wheels and assembly wheel(s) may be calculated and modified if required to accommodate vehicle turning circles, implement size and available turning area. Such calculations may readily be made by a person of skill in the automechanical and steering arts.

The steering mechanism suitably includes a hydraulic ram for moving the wheel between a straight and a tuner position. Suitably, the ram is hydraulically connected to the vehicle hydraulic system. Where the assembly includes two wheels, the steering mechanism may include a single ram in combination with a drag link so as to coordinate the steering of the two wheels. In an alternative arrangement, the steering assembly can include a ram for turning each wheel.

The cooperation of the steering mechanism may be controlled to engage before a turn and disengage after a turn. Such control may be automatic or manual. For example, the cooperative steering may be automatically engaged as the vehicle reduces speed to prepare for a turn. The speed at which the mechanism is engaged or disengaged will depend upon the safe turning speed for the vehicle and will therefore vary with the size and weight of the vehicle. Determining the relevant speed may be accomplished readily by a person of skill in the art. After the turn has been completed and the vehicle increases in speed the steering can be disengaged so that the wheels can either travel freely, be locked into a straight forward direction or further controlled in a different mode of operation as described further below.

In a preferred embodiment, the steering mechanism is also controlled to cooperate with the vehicle front wheels whilst other than turning such as travelling at normal speeds when working a field. When working a field, although a tractor travels in straight rows, constant adjustment is required to maintain the correct line, as is critical for row crop agriculture. This constant adjustment is required as the path of the implement is moved by contact with the ground. Further, gradual turns are executed on contoured rows or to go around obstacles such as trees. In this embodiment, the wheel(s) are able to cooperate in a first turning mode as discussed above and a second field mode in which the wheel(s) cooperate to turn in the same direction as the vehicle front wheels.

Implements linked to a vehicle by a two or three point hitch have a disadvantage that steering of the vehicle amplifies movement of the implement in the opposite direction. In row cropping, this movement can cause a number of disadvantages such as damage to crops, cause seeds, herbicide, pesticide to be planted or dispersed into interrow areas. Under normal circumstances, for example, when a tractor turns left, the front wheels turn left. The back of the tractor and implement turn to the right before they acquire the right line. However, in the preferred embodiment having a field mode for wheel cooperation, the assembly wheel(s) immediately turns left with the tractor front wheels so the steering adjustment is essentially instant with no uneven serpentine movement.

The steering mechanism may be computer or manually controlled to change between turning mode in which the assembly wheel(s) turn in the opposite direction to the vehicle front wheels and a field mode in which the wheel(s) turns in the same direction as the vehicle front wheels.

This preferred embodiment of the present invention, in which the steering mechanism operates in a turning and a field mode has particular application in what is known in the art as precision or guidance farming. As discussed above, in row crop farming, well defined and calculated row spacing enables optimizes productivity. It also optimizes machinery performance and can provide for easier automation. It will be appreciated that drifting off course can result in a number of disadvantages including crop damage, inappropriate application of herbicides and fertilizers, soil damage and the like. In precision guidance or precision farming in which GPS is used to accurately guide a tractor along the rows. The tractor is computer controlled to operate in GPS mode and to automatically steer the tractor along the rows. At the end of the row, the operator typically turns from GPS mode to manual mode for turning at the headland. After turning, the GPS mode is reengaged.

Thus in accordance with a further broad form of the invention, the steering mechanism can be integrated with the GPS control such that it steers in a GPS field mode when the tractor is guided by GPS and automatically transfers to turning mode when the tractor is in manual mode.

In a further embodiment, the assembly may further be controlled so as to provide a further steering mode in which when he vehicle is being manually driven at speeds greater than a slow turning speed, such as when the vehicle is transporting the implement between fields or along a road, the wheels(s) coordinate in the same manner as GPS field mode, i.e. turn in the same direction as the front wheels of the vehicle. This mode may be referred to as travel or tractor mode.

In a preferred form of the invention, the wheel attachment assembly further includes a lift actuator for lifting the rear of the implement. Any suitable lift actuators capable of lifting the required loads may be used. Preferred actuators are hydraulic rams that can be operatively connected to the vehicles hydraulics.

When mounted to an implement carried by a two or three point hitch, the lift actuator can be activated to assist the hitch in lifting the weight of the implement. In this embodiment where the assembly has a lift capability, the preferred wheel has a pneumatic tyre, dimensioned to carry the necessary load.

Conventional two or three point hitches control the draft or pulling power by sensing the pull, usually on the lower lift arms of the hitch. If the draft increases, such as when a ground engaging tool depth goes too low, the hydraulic system automatically raises the implement until the draft decreases, at which point the implement is lowered. In a preferred form of the present invention, the hitch draft control is integrated with the controller so that the lift actuator can cooperate with the hitch draft control to lift the rear of the implement together with the hitch to control draft. In this way, the efficiency of draft control can be improved. An exemplary advantage of this is a greater control of working depth, which can be important for tasks such as planting in which depth is important.

According to a further broad form of the invention there is provided a wheel attachment assembly mountable to an agricultural implement that is drawn by a vehicle having front steering wheels, the assembly including:

at least one ground engaging wheel;

a mounting arrangement for mounting the assembly to the rear of the implement;

a lift actuator for lifting the rear of the implement relative to the wheel; and

a steering mechanism for steering the wheel; wherein the steering mechanism is controllable such that the at least one wheel is steered in cooperation with the vehicle front wheels when the vehicle is turning.

According to a further broad form of the invention, there is provided a wheel attachment system for an agricultural implement drawn by a vehicle comprising:

a wheel attachment assembly mountable to an agricultural implement that is drawn by a vehicle having front steering wheels and a rear implement lifting capability, the assembly including:
at least one ground engaging wheel;
a mounting arrangement for mounting the assembly to the rear of the implement;
a steering mechanism for steering the wheel; and
a controller for controlling the steering mechanism such that the wheel is steered in cooperation with the vehicle front wheels when the vehicle is turning.

According to still a further broad form of the invention, there is provided a wheel attachment system for an agricultural implement drawn by a vehicle comprising:

a wheel attachment assembly mountable to an agricultural implement that is drawn by a vehicle having front steering wheels and a rear implement lifting capability, the assembly including:
at least one ground engaging wheel;
a mounting arrangement for mounting the assembly to the rear of the implement;
a lift actuator for lifting the rear of the implement relative to the wheel;
a steering mechanism for steering the wheel; and
a controller for controlling the steering mechanism such that the wheel is steered in cooperation with the vehicle front wheels when the vehicle is turning.

According to a still further embodiment of the present invention there is provide a method of guiding an agricultural implement towed by a vehicle having front steering wheels, comprising:

providing a wheel attachment assembly having at least one ground engaging wheel and a steering mechanism for steering the at least one wheel;

mounting the wheel attachment assembly to the rear of the towed implement; and

providing a controller for controlling the steering mechanism so as to control the steering of the at least one wheel such that the at least one wheel is turned in cooperation with the vehicle front wheels when the vehicle is turning.

The wheel attachment assembly of the invention may include one or more wheels. The number of wheels may depend upon the width and weight of the implement. Suitably the assembly includes at least two wheels so as to provide stabilization. Alternatively, although not as preferred is to mount at least two single wheeled assemblies to the rear of an implement. In this case, each individual wheel may be independently connected to a controller for steering.

In the preferred apparatus having two wheels it is preferred that the steering mechanism is arranged to steer the wheels at the same time and at substantially the same steering angle.

Suitably, the assembly includes a frame, an implement mount at one end and at least two, preferably a pair of spaced wheels mounted at the other end. The spacing of the wheels is typically determined to optimize the stability that can be conferred to the towed implement.

The steering mechanism can be any suitable arrangement by which wheels can be actuated to turn. A preferred embodiment is that the mechanism includes one or more hydraulically operated rams that can be connected to the hydraulics on the pulling vehicle.

In a preferred embodiment in which either the assembly has a lift actuator and two or more wheels or more than one assembly having a single wheel or a combination thereof, the assemblies include a load sharing mechanism for sharing or distributing the load substantially evenly between the wheels. In the absence of any load sharing capability on uneven ground and when turning, one wheel will bear more load than the other. This can lead to instability and possible damage to the wheel supporting structures. This is true for when the implement is in the lowered work position or in the lifted position in which the wheels bear greater weight than in the work position in which the implement is lowered. When in the work position and the load is shared between wheels, the implement weight may be increased without unduly compromising the stability and safety of the vehicle. As mentioned above, it is desirable to be able to use wider implements to increase cropping efficiency. It is also desirable to be able to carry heavier loads of seeds, fertilizer, pesticides and herbicides.

The load sharing or suspension may be any suitable mechanism. Shock absorbers, and suspension mechanisms are well known in the mechanical and arts. However, a preferred embodiment of the present invention the assembly includes a frame with an implement mount at one end, two steerable wheels spaced apart and mounted to an arm or beam mounted to the other end of the frame by a link, wherein the link is pivotally from side to side as they travel along undulating ground.

In a preferred form of the invention, the wheel of the lift assist wheel assembly comprises a wheel mounted from one side only to a pivot joint.

The pivot joint may have a sleeve and an axially rotatable shaft to which the wheel is mounted. The steering mechanism can rotate the shaft with respect to the sleeve.

The assembly may comprise two wheels, each with a pivot joint, the pivot joints being located at either end of an arm or beam. In this case, the steering mechanism is arranged to rotate the shaft of both pivot joints such that both wheels are steered at the same time.

Each shaft of each pivot point may be coupled to a plate that extends radially with respect to the axis of rotation of the respective shaft, and each plate is connected by a rod pivotally rotation of the respective shaft.

The assembly typically includes a frame to which the beam is pivotally connected.

The frame may be generally A shaped with a swivel joint at its apex of the A shaped frame so as to provide the pivotal connection to the beam.

The legs of the A shaped frame may be adapted for pivotal mounting to an implement. Each leg may be pivoted with respect to the implement by the lift actuator.

The lift actuator may be two hydraulic rams, each ram extending between the rear of the implement and one of the legs.

### BRIEF DESCRIPTION OF THE DRAWINGS

FIG. 1 shows a plan view of a preferred wheel attachment assembly of the present invention.

FIG. 2 is a perspective view of the assembly shown in FIG. 1.

FIG. 3 is a side view of the assembly shown in FIG. 1.

FIG. 4 is a schematic side elevation of the wheel attachment assembly of FIG. 1 in a work position.

FIG. 5 is a schematic side view of the wheel attachment assembly of FIG. 1 in the lift position.

FIG. 6 is a schematic view of the wheel attachment assembly mounted to a tractor drawn implement.

FIG. 7 is a schematic side view of the mounted wheel attachment assembly as shown in FIG. 6 in the work position.

FIG. 8 is a schematic side view of the mounted wheel attachment assembly as shown in FIG. 6 in the lifted position.

FIG. 9 is a schematic plan view of a an alternative wheel attachment assembly mounted to a tractor towed implement.

FIG. 10 is a rear view of the wheel attachment assembly as shown in FIG. 1.

FIG. 11 is a plan view of the assembly shown in FIG. 1 with the wheels turned.

FIG. 12 is a schematic view of a further preferred wheel attachment assembly of the present invention.

FIG. 14 is a schematic block diagram of a control system for controlling the lift assist wheel assembly of FIG. 1.

FIG. 15 is a schematic view of a row crop field being worked by the lift assist assembly of FIG. 1 mounted to an implement drawn by a tractor.

### DETAILED DESCRIPTION OF THE INVENTION

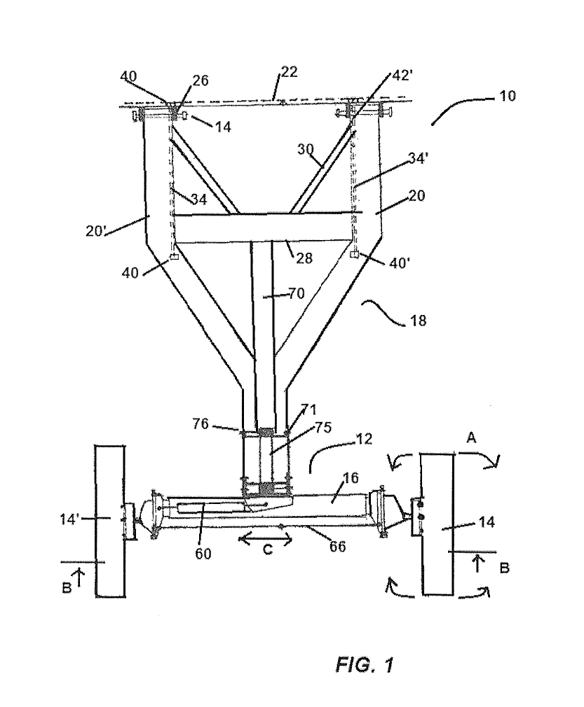

FIG. 1 shows a plan view of a preferred wheel attachment assembly 10 of the present invention. The assembly 10 has a wheel section 12 with two wheels 14, 14′ connected by a beam or connecting bar 16. The wheel section 12 is pivotally linked to a mounting frame 18 (details of the linkage will be discussed below). The mounting frame 18 has parallel mounting arms 20, 20′ for pivotal attachment to the rear of an agricultural implement 22. The mounting arms 2, 20′ are pivotally connected to the implement 22 by bolts 24 that extend through holes at the end of the mounting arms 20, 20′ and complimentary lugs 26 on the implement 22.

The frame 18 is strengthened by a cross member 28 and braces 30. A central shaft 70 connects the cross bar 28 to the wheel section 12. Members 32 extend from the cross member 28 and come together and connect to a shaft 70 towards the wheel section 12 to define an A shaped portion of the frame 18.

The assembly 10 includes two hydraulic rams 34, 34′, each ram having one end 40, 40′ pivotally coupled to the mounting frame 18 by a bolt 24 passing through a lug 26 on the frame 18. The opposite end 42, 42 is pivotally attached to the implement, also by a conventional bolt and lug arrangement.

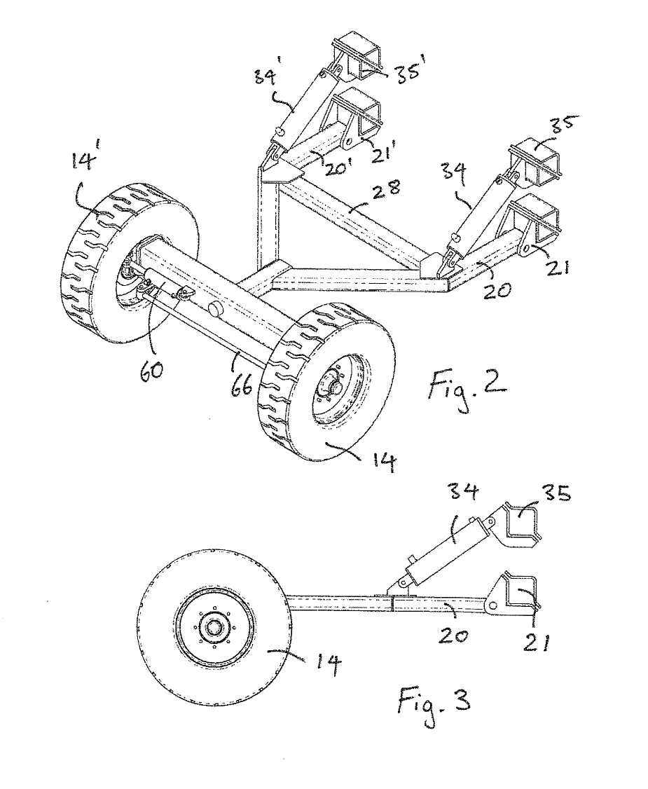

FIGS. 2 and 3 show perspective and side views of the assembly shown in FIG. 1. The only difference is that the ends of arms 20, 20′ and piston 34, 34′ have housings 21, 21′, 35, 35′ for receiving a complimentary bar on the implement so as to be mounted thereto.

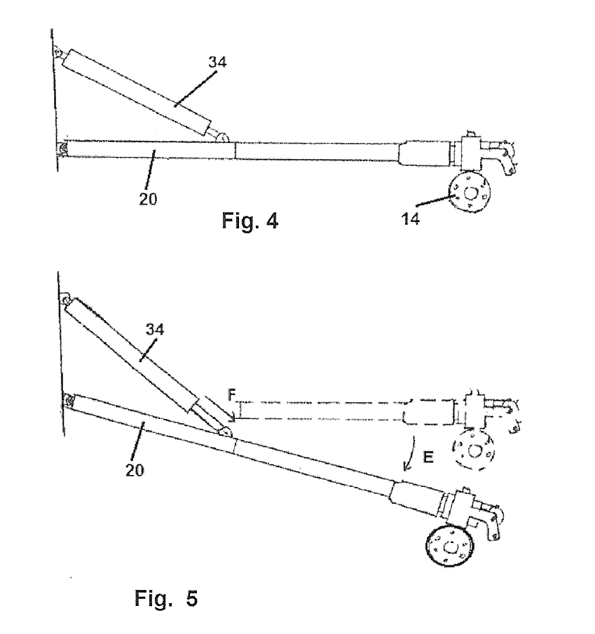

FIGS. 4 and 5 show the operation of the rams 34, 34′. FIG. 2 is a side view of the assembly 10 in the lowered position. Extension of ram 34 in direction F provides a force on the wheel section shown by E. The resistance of the ground forces the implement 22 to be lifted with respect to the wheels as shown in FIG. 3. FIG. 3 shows in phantom the position of the assembly 10 in the lowered position of FIG. 2.

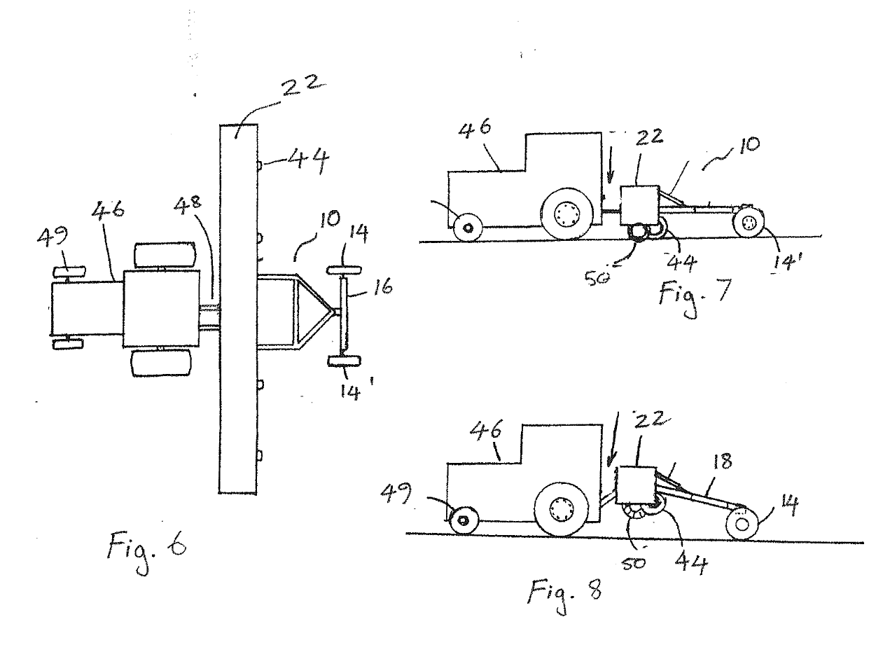

FIGS. 6 and 7 show a plan and side views of the assembly 10 mounted to an implement 22 that is typically a cultivator with cultivator discs 44 spaced along the length thereof. The implement 22 is hitched to a tractor 46 with a three point hitch 48 and front wheels 49. However, the implement is only attached to the lower lifting inks of the hitch. This will be discussed in more detail below. The cultivator has wheels 50 to help support its weight during normal operation.

The tractor 46 can provide a power take-off and/or hydraulic power to the cultivator 22 as well as hydraulic power to the lift wheel assembly 10 under the control for a computer. Additionally, the tractor 46 is able to provide a lifting force to the implement 22 through the three point hitch. When this force is applied in combination with the lift assist wheel assembly 10, the implement may be lifted above the ground as shown in FIG. 8.

When a weight is lifted by a three point hitch, all the weight is transferred to the back wheels. An advantage of the present invention is that when the machine is lifted, the implement can be attached to the bottom links only so that when the machine is lifted the weight is carried by both the tractor front and rear wheels, as well as the lift assist wheels.

There are some advantages in having the implement attached to only the bottom links of a three point hitch. For example, when an implement is hitched to a three point hitch, if the front tractor wheels go over a bump or a hole, the rear of the implement falls or lifts as its position with respect to the rear of the tractor is fixed by the three point hitch. This is particularly evident when pulling onto the channel and headland as this often has a rise in the headland area. In the tail drain end of the field, the front wheels often drop into the drain and the implement lifts up. Further, when the front wheels go up on the edge or road of the tail drain, the implement digs in and tynes can break.

Under normal circumstances, a three point attachment with the upper stabilizer bar is important for stabilizing the implement from side to side moment. However, in the present case, the implement is stabilized by the wheel attachment assembly. Thus by not being attached to the upper link of the three point hitch, the implement is able to pivot up and down, thereby avoiding or minimizing the above disadvantages.

The assembly may also include sensors such as electronic sensors to measure the angle of the lift assist hinges. This provides an indication of height so that the weight distribution between the tractor hitch and the assembly can be adjusted as required by regulating the height.

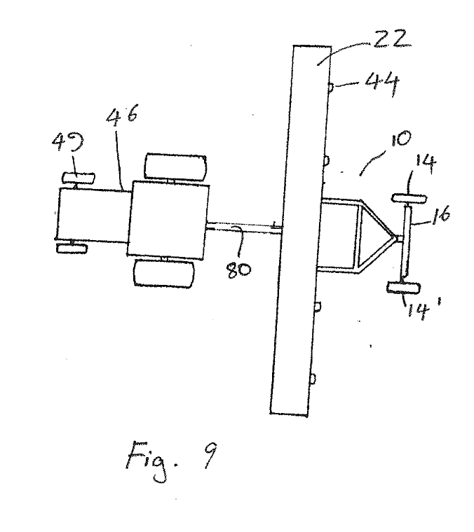

FIG. 9 shows an alternative arrangement in which the cultivator 22 is attached to the tractor 46 by a drawbar 80. In this embodiment, the wheel attachment assembly provides guidance and steering to the towed implement. This provides sideways control necessary for towing the implement along slopes, contoured rows, and variable soils without incurring unacceptable implement drift.

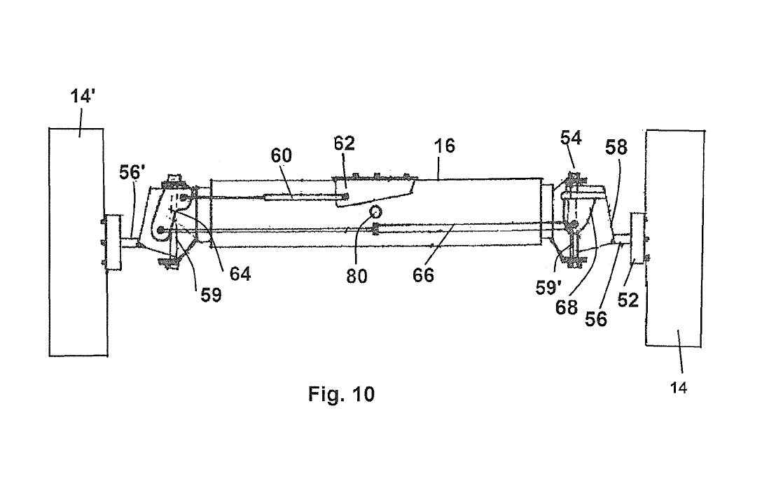

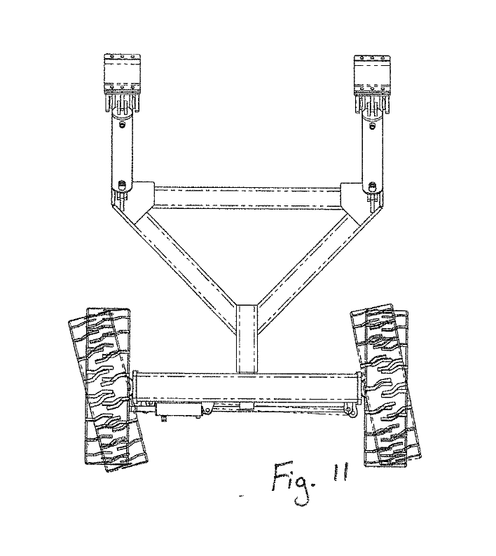

Turning back to FIG. 1, and also with reference to FIG. 10, the wheel section will now be described in detail. As the two wheels 14, 14′ are mounted identically, the discussion below in relation to wheel 14 will apply equally to wheel 14′.

Wheel 14 is mounted by an axel hub 52 to a pivot joint 54 on one side of the wheel. The pivot joint 54 includes an axially rotatable shaft 56 (shown in FIG. 10) disposed within a sleeve 58 such that the shaft 56 is able to rotate within the sleeve 58. The pivot joints 54, 54′ are mounted at opposite ends of beam 16.

The assembly 10 includes a hydraulic ram 60 connected by a bracket 62 to the beam 16 at one end, an arm 64 in the form of a curved plate connected to a pivot shaft 59 and the other end of the ram 60, a rod or drag link 66 connecting the arm 64 to another arm 68, also in the form of a curved plate. Arm 68 is connected to the shaft 56 and pivots about the axis of rotation of the shaft 56. The ram 60 is connected to the arm 64 so that extension or retraction of the ram 60 causes corresponding pivoting of the arm 64 about the axis of rotation of the shaft 56′. The rod 66 is connected to the arms 64, 68 at the same radial distance from the axis of rotation of each shaft 60, 60′. Movement of the rod 66 (indicated by arrow C) causes reciprocal pivoting of arm 68 when arm 64 is pivoted as a result of extension or retraction of the ram 60. Pivoting of the arms 64, 68 causes steering with substantially the same angular movement of the wheels 14, 14′ as indicated by arrows A (FIG. 1).

FIG. 11 is a plan view of the assembly of FIG. 1 in which the wheels 14, 14′ have turned in an anticlockwise direction.

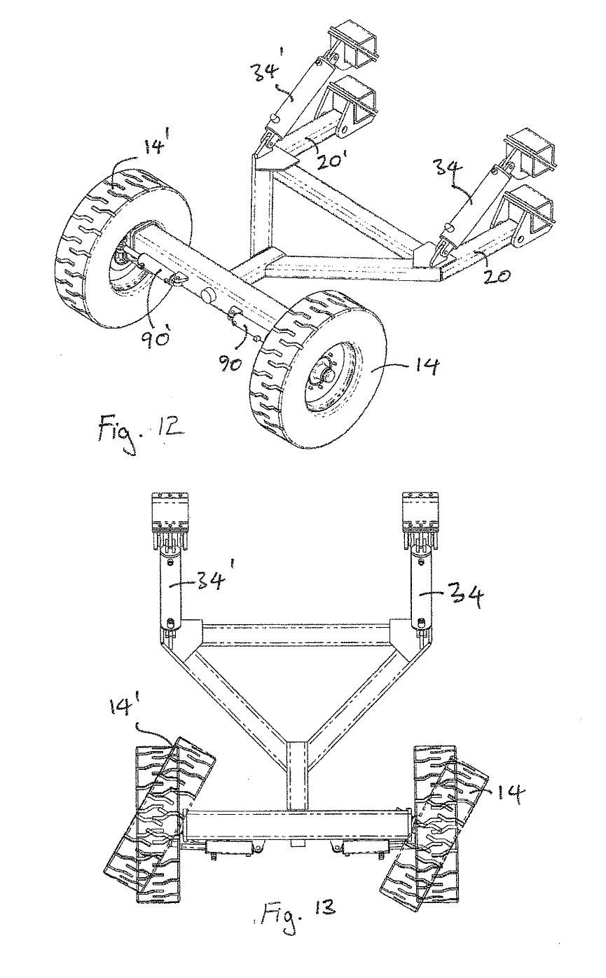

FIGS. 12 and 13 show perspective and plan views of an alternative assembly of the present invention. This assembly is similar to that of FIG. 1 and the same reference numerals are used to illustrate the same features. The difference with this embodiment is the presence of a ram 90 90′ to operate each wheel 14, 14′.

With reference to FIG. 1, the manner in which the wheel section 12 is linked to the mounting frame 18 will be explained. At the end of shaft 70 is a bracket 71 that supports a pin 75. The pin is fixed at one end 76 to the shaft 70 and is rotatably received within in a hole 80 in the beam 16 (shown in FIG. 10). The beam 16 is retained on the end of the pin 75 by suitable means, such as a washer and bolt of circlip. In an alternative arrangement shaft 70 is connected to the beam 18 and is connected by brackets and bearings to the apex 74 of the A shaped section of frame 18.

The pivoting of the beam 18 functions as a suspension or load bearing system to allow the wheels to travel over uneven ground whilst sharing the load evenly.

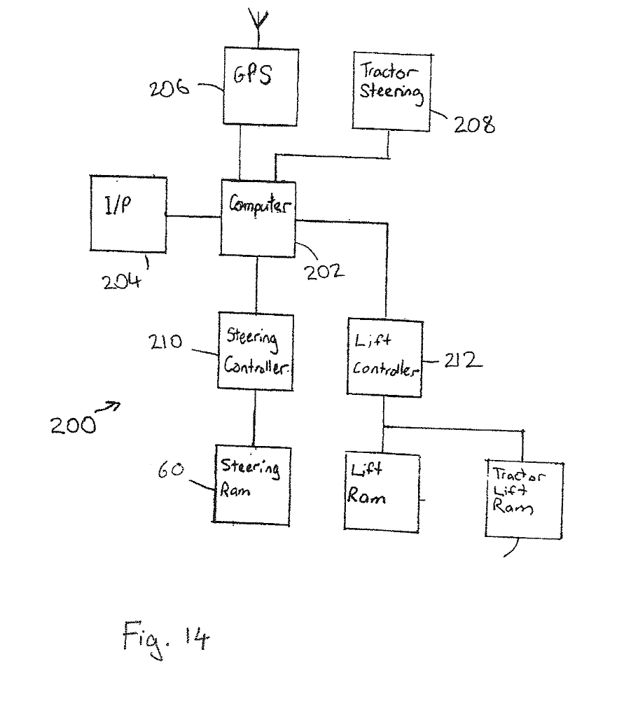

Referring to FIG. 14, a control system for control of the lift assist wheel assembly 10 is shown. The system 200 comprises a computer 202, a user input 204, a global positioning satellite (GPS) input, a tractor steering position input 208, a steering controller 210 and a lift controller 212. An alternative location determining system could be used in place of the GPS input 206.

The steering controller 210 is an interface between the computer 202 and the steering ram 60 that controls the flow of hydraulic fluid into or out of the ram 60 as determined by calculations performed by the computer 202. The lift controller 212 is an interface between the computer 202 and the lift rams of the hitch as determined by calculations performed by the computer 202.

The computer 202 runs a computer program stored in a storage device to receive input signals from the inputs 204, 206 and 208 and to perform computations using those input signals to produce output signals sent to the controllers 210 and 212,

The user input 204 may be a switch, button, kepypad, joystick or the like that receives an input form a user, such as the tractor operator to the computer 202. The user may use the input to select between GPS controlled steering mode and a turning mode for headland turning. In headland steering mode the tractor is going slowly and the lift assist wheels are steered in the opposite directions to that of the tractor wheels which reduces the turning circle. In headland mode, the driver may be in control of the tractor steering. In this case, sensors measure the steering angle of the tractor wheels and the computer calculates the required cooperative steering of the lift assist wheels. Prior to entering headland mode steering the implement will be raised through the cooperation of the ram on the wheel assembly and the lifting arms of the three point hitch. The lift controller 212 co-ordinates the respective lifting. The relevant heights of the respective assembly and hitch lift arms can be measured by sensors known in the art and communicated to the computer for processing.

There are some tractor control systems that use GPS to also control the headland turns. In this case, there is a GPS field mode and a GPS headland mode. Selection of GPS field mode and GPS headland mode may be manual or controlled by the controller in response to a GPS signal that detects that the tractor is approaching the headland.

In GPS mode, the position of the tractor is determined by GPS input 206 and the tractor steering is controlled according to the position to allow the tractor to traverse a predefined route stored in the computer 202. In this mode, the assembly wheels turn in the same direction as the tractor wheels. The computer determines the steering angle of the tractor wheels in response to the GPS position. The computer may simultaneously determine the correct steering angle of the assembly wheels. Alternatively, the assembly steering may be controlled in response to sensor measurement of the tractor steering angle.

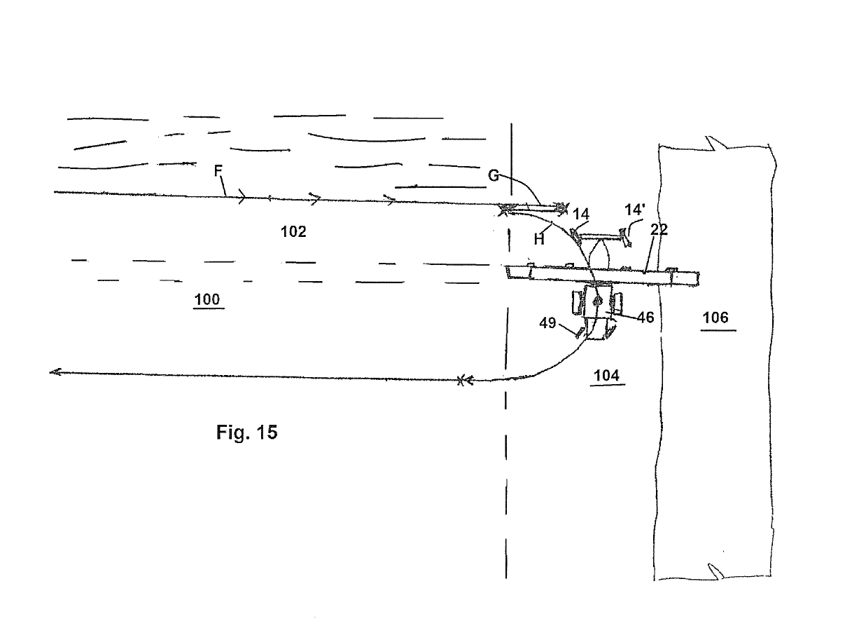

An example method of operation of the present invention will now be described with reference to FIG. 15 which shoes an area of land 100 under row cropping cultivation. At the end of the land is a headland 104 bordered by an irrigation channel. In irrigation row cropping water is distributed to the crops through furrows in the crops. Accordingly the headland area is crossed with furrows and is very uneven.

A tractor 46 has towed a cultivator 22 along a pass having a centre line 102 in the direction of arrow F. Travel along the pass is in GPS field mode in which the position of the tractor is guided by GPS. As the implement reaches the end of arrow F, the mode is switched to headland turning mode (either manually or by the GPS determining that the tractor is at the end of the row). The switch to headland mode causes the computer 202 to send a signal to lift controller 22 to activate the three point link rams and the lift assist rams to raise the cultivator so that the discs are clear of the ground.

The tractor then reverses along path G with the implement raised. As the rear tractor wheels reach the end of G, the driver selects forward gear and turns the tractor around the headland following curve H. The tractor front wheels are turned in the direction of field 100, whereas the wheels 20, 20′ of the assembly 10 are turned in the opposite direction. The ground along path H undulates because of the irrigation furrows. Having the assembly wheels being able to accommodate this uneven ground by means of the beam pivotally attached to the shaft enables the wheels to accommodate the uneven ground so as to share the load.

When the turn has been completed, the mode is returned to GPS field mode, the lift controller 212 causes the implement to be lowered to a ground engaging working position.

It will be appreciated that there are a number of advantages of the lift assist wheel assembly and system of the present invention over conventional lift assist wheel assemblies. An important advantage is the ability to reverse and especially reversing when doing a headland turn in a row crop field.

A further advantage is the ability to share the weight evenly between the wheels so as to accommodate undulating ground. This increase stability, allows faster travel speeds when the implement is lifted and can improve safety.

A further advantage is that heavier implements can be pulled. This means that wider implements may be used which translates to more rows being worked at once. A further advantage of an increase in weight is to be able to carry heavier loads of seeds, planting materials, herbicides, pesticides and the like.

A further advantage is to manage head row turns and to reduce the turning circle of a pulled implement. An advantage in accurate turning is to manage guess rows. Guess rows are where two adjoining implement swaths meet. Excessively wide or narrow guess rows made when preparing a filed can lead to crop damage during cultivation.

It will be appreciated that various changes and modifications may be made to the invention as described and claimed herein without departing form the spirit and scope thereof.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

We claim:

1. A wheel attachment assembly mountable to an agricultural implement that is drawn by a vehicle having front steering wheels and, the assembly including:
at least one ground engaging wheel;
a mounting arrangement for mounting the assembly to the rear of the implement; and
a steering mechanism for steering the wheel; wherein the steering mechanism is controllable such that the at least one wheel is steered in cooperation with the vehicle front wheels when the vehicle is turning.

2. The assembly of claim 1, wherein the at least one wheel is steered in the direction opposite to that in which the vehicle front wheels are turning.

3. The assembly of claim 2, wherein the steering control that controls the steering of the at least one wheel in the opposite direction is engaged before a turn and is disengaged after the turn.

4. The assembly of claim 3, where disengagement and/or engagement is controlled manually.

5. The assembly of claim 3, wherein disengagement and/or engagement is controlled by a controller.

6. The assembly of claim 5, wherein the controller coordinates the lift actuator with engagement and/or disengagement of the steering control.

7. The assembly of 1, wherein the steering mechanism is further controllable such that the at least one wheel is steered in the same direction as the vehicle front wheels when the vehicle is not turning.

8. The assembly claim 7, wherein the steering mechanism is integrated with a GPS steering control on the vehicle that controls the steering of the vehicle front wheels.

9. The assembly claim 1, wherein the assembly further includes a lift actuator for lifting the rear of the implement with respect to the least one wheel.

10. The assembly of claim 9, wherein the assembly includes two wheels.

11. The assembly of claim 10, which includes a mechanism for sharing a load between the two wheels.

12. A wheel attachment system comprising:
a wheel attachment assembly mountable to an agricultural implement that is drawn by a vehicle having front steering wheels, the assembly including:
at least one ground engaging wheel;
a mounting arrangement for mounting the assembly to the rear of the implement;
a steering mechanism for steering the wheel; and
a controller for controlling the steering mechanism such that the wheel is steered in cooperation with the vehicle front wheels when the vehicle is turning.

13. The system of claim 12, wherein the controller controls the at least one wheel to turn in the opposite direction to the front wheels when turning.

14. The system of claim 13, wherein the steering control that controls the cooperative steering of the at least one wheel in the opposite direction is engaged before a turn and is disengaged after the turn.

15. The system of claim 14, where the controller can be actuated manually to disengage and/or engage the cooperative steering.

16. The system of claim 15, wherein disengagement and/or engagement is controlled by the controller in response to a data input.

17. The system of claim 16, wherein the data input is selected from a decrease in vehicle speed or a predetermined global position.

18. The system of claim 12, wherein the lift attachment assembly includes a lift actuator for lifting the implement relative to the wheel and the controller also controls actuation of the lift actuator.

19. The system of claim 18, wherein the controller coordinates the lift actuator with engagement and/or disengagement of the steering control.

20. The system of claim 18, wherein the implement is drawn by a vehicle having a hitch with draft control and the vehicle draft control is integrated with the controller so that lift actuation can cooperate with the draft control.

21. The system of claim 12, wherein the steering mechanism is further controllable such that the at least one wheel is steered in the same direction as the vehicle front wheels when the vehicle is not turning.

22. A method of guiding an agricultural implement towed by a vehicle having front steering wheels, comprising:
providing a wheel attachment assembly having at least one ground engaging wheel and a steering mechanism for steering the at least one wheel;
mounting the wheel attachment assembly to the rear of the towed implement; and
providing a controller for controlling the steering mechanism so as to control the steering of the at least one wheel such that the at least one wheel is turned in cooperation with the vehicle front wheels when the vehicle is turning.
